(19) United States
(12) Patent Application Publication
(10) Pub. No.: US 2018/0049453 A1
(43) Pub. Date: Feb. 22, 2018

(54) COATED FOOD PRODUCTS

(71) Applicant: Freddy Hirsch Group AG, Buro 2 Stock (CH)

(72) Inventors: Hermann August Schultz, Melkbosstrand (CH); Johannes Gerharuds Maria Goorhuis, PG Amersfoort (NL); Andries Wynand Van Zyl, Cape Town (ZA); Johannes Christiaan Du Preez, Cape Town (ZA)

(21) Appl. No.: 15/586,845

(22) Filed: May 4, 2017

(30) Foreign Application Priority Data
May 6, 2016 (GB) 1607992.3

(51) Int. Cl. A23L 13/60; A23P 20/10; A23P 30/25; A23L 27/20; A23L 27/26; A23L 27/14

(52) U.S. Cl. CPC A23L 13/65; A23P 20/10; A23P 30/25; A23V 2002/00; A23L 27/26; A23L 27/14; A23L 27/20

(57) ABSTRACT

A coating material for a food product includes a manipulated pH of the environment to produce a coating material that is particularly suitable for use in the extrusion coating of food products.

### CROSS-REFERENCE TO RELATED APPLICATIONS

This application claims the priority benefit of United Kingdom Patent Application No. 1607992.3 filed May 6, 2016, the entire contents of which are incorporated herein, where permitted.

### BACKGROUND

Synthetic coatings for food products, such as sausage casing, are well known in the art. Synthetic coatings can be made from cellulose, though collagen and even plastics.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the disclosure relate to a method for preparing a coating material for a food product, as well as a method for coating a food product. The coating materials are particularly suitable for use in the extrusion coating of food products.

The present disclosure provides a method for preparing a coating material for a food product, said method comprising: a gel preparation stage in which a composition comprising an anionic polysaccharide is maintained at a pH of from 3.3 to 3.9 to increase its viscosity; and a coating formation stage in which the gel is homogenised. A coating material obtainable by such methods is also provided.

In a further aspect, the present disclosure provides a method for preparing a gel for use in preparing a coating material for a food product, said method comprising and maintaining a composition comprising an anionic polysaccharide at a pH of from 3.3 to 3.9 to increase its viscosity. A gel obtainable by such methods is also provided.

In a further aspect, a method is provided for preparing a coating material for a food product, said method comprising homogenising such a gel.

In a further aspect, the present disclosure provides a method for preparing a coated food product which comprises: a coating step, the coating step comprising applying a coating material obtainable by the methods described herein to a food product. A coated food product obtainable by such methods is also provided.

In a further aspect, the present invention provides a kit comprising: an anionic polysaccharide; and instructions for preparing a gel, a coating material, or a coated food product using the methods disclosed herein.

A kit is also provided which comprises: an anhydrous anionic polysaccharide; and an acid or an acidic buffer.

In a further aspect, the present disclosure provides the use of a pH of from 3.3 to 3.9 in a method for preparing a coated food product as disclosed herein for enhancing the porosity of the coating. Further provided is the use of a pH of from 3.3 to 3.9 in a method for preparing a coated food product as disclosed herein for improving adhesion of the coating to the food product. Still further provided is the use of a pH of from 3.3 to 3.9 in a method for preparing a coated food product as disclosed herein for reducing the tensile strength of the coating.

In a further aspect, the present disclosure provides the use of a coating material obtainable by a method disclosed herein for preparing a coated food product in which the coating has a skinless feel. Further provided is the use of a coating material obtained by a method disclosed herein for improving browning of a food product coated with the material during cooking.

In a further aspect, the present disclosure provides an apparatus for preparing a coated food product, wherein the apparatus comprises: a tank in which a gel is prepared using a method disclosed herein; a homogeniser in which a coating material is prepared from the gel using a method disclosed herein; and a coating device in which a coated food product is prepared using a method disclosed herein; wherein the apparatus comprises a storage area containing an anhydrous anionic polysaccharide, said storage area adapted to provide the tank with said anhydrous anionic polysaccharide.

### DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawing. The drawing is not necessarily to scale. In general, operations of disclosed processes may be performed in an arbitrary order, unless otherwise provided in the claims

FIG. 1 is a graph showing the effect of pH on the viscosity of a composition comprising alginate in an amount of 5% by weight of the composition; and

FIG. 2 is a graph showing the effect of pH during preparation of a coating material on the tensile strength of the coating once extruded.

### DETAILED DESCRIPTION

Synthetic coatings can be made from cellulose, though collagen and even plastics. It has been found that a disadvantage of these coating materials is that they tend to confer an unnatural and unappealing texture to the outside of a food product and, in some cases, the coating is inedible. This means that synthetic coatings often have to be removed from the food product before consumption, particularly where an imperceptible coating is desirable such as with a skinless sausage. This also adds to the risk of food contamination due to added handling of the food product.

Anionic polymers can be used in synthetic food coatings, such as sausage casings. Alginate is an edible anionic polymer which is made up of two different uronic acid monomers, namely guluronic acid (G-blocks) and mannuronic acid (M-blocks).

Alginate can be used to form sausage casings as part of a process in which a solution of alginate is extruded through a circular die around a food product and subsequently treated with calcium chloride. During this process, the alginate solution undergoes a gelification process in which matrices of cross-linked alginate chains form. The M-blocks form linear molecular chains (M-M-M-M-M), whilst the G-blocks form folded structures (G-G-G-G). Alternating regions consisting of M- and G-chains form the fundamental alginate structure, which can vary with seaweed type and seasonal climate.

In some situations, in order for extrusion on to the food product to be successful, the viscosity of the alginate coating material is closely controlled. If the viscosity is too low, then the coating material can liquify at the extrusion interface before gelification. Machine limitations can also result in the coating being sucked into the water separator, leading to insufficient casing supply at the extrusion point. If the viscosity is too high, then the pumping efficiency of the extrusion equipment is reduced which can lead to an irregular supply of coating material to the extrusion point. Even where a regular supply is achieved, uneven coating of the food product can result in an interrupted casing.

Viscosity can be controlled using viscosity modifying agents, such as hydrocolloids, insoluble fibers, liquid smoke and plasticizers. However, these viscosifying agents are expensive. Moreover, each of the viscosity modifying agents has further effects on the casing material. For instance, the use of liquid smoke may shorten the texture of the casing material, as well as impart a particular flavour on to the food product. Similarly, the use of hydrocolloids may lead to an oily feel to the casing. Whilst each of these further effects may be desirable in some types of sausage, they may not be desirable in other types of sausages. For example, it is generally desirable to have a smoky flavour in dried sausages, whereas an oily feel to the casing may be undesirable.

A very particular combination of different viscosity modifying agents can be required in coating materials in order to produce sausages of different types with different target skin properties. Moreover, since the efficacy of viscosity modifying agents may vary from batch to batch, frequent fine tuning of the coating material is required to ensure that target viscosities and target properties are achieved. In sum, controlling the viscosity of a coating material primarily with viscosity modifying agents, whilst achieving a target texture and flavour, can be challenging.

Accordingly, there remains a need for a method for coating a food product, in which the characteristics of the coating material (e.g. its viscosity before extrusion and/or its properties after extrusion) may be controlled more easily.

Alginate can be used as a film forming element in co-extrudable coatings, such as in the formation of food casings. In general, such use has involved compositions comprising water, alginate, acidifier and starch/cellulose at a pH of 4 to 4.5. However, the products formed are characterised by the formation of strong and dense coatings.

However, at such pH levels, the alginate in the composition reacts with Ca²⁺ ions to form a hydrogel. The G-blocks of adjacent alginate chains form a type of “egg box” structure in which cavities containing the Ca²⁺ ions act as cross-linkers. These intermolecular electrostatic forces are rather strong.

Further, the M-block fraction of the molecules is not able to participate in gelation, because at pH levels greater than 4, the molecular chains are negatively charged and therefore subject to electrostatic repulsion. Moreover, advantageous binding sites are not formed as is the case with G-block regions.

In some situations a method for preparing food products by means of processing food particles with a gelling agent such as alginate can be used. An acidic buffer solution having a pH in the range of from 3 to 6 is contacted with the gelling agent immediately before, or during, extrusion in order to improve adherence of the gelling agent to the food particles. This effect is achieved by using the buffer to prevent ionic strength differences between the food particles and the gelling agent. It will be appreciated that the manner in which the buffer is used does not significantly alter the pH of the gelling composition.

The addition of the acidic buffer can increase the hydrogen bonding between the gelling agent and the proteins present in the food particles. While the addition of such an acidic buffer may improve the adhesion of alginate casings when certain types of fillings are employed, as is demonstrated in Comparative Experiment C below, this approach can be unsuccessful when employed in fine emulsion-type sausages, because insufficient hydrogen bonding occurs with the proteins in such an emulsion.

Aspects of the disclosure are based on the unexpected discovery that, by manipulating the pH of the environment to which alginate is exposed, the viscosity of an alginate coating material can be closely controlled. This effect is believed to stem from protonation of mannuronic acid and guluronic acid moieties in the alginate that occurs over a narrow range of pH levels. Once protonation of these moieties occurs, repulsion between the chains caused by negatively charged moieties decreases, whilst hydrogen bonding between the chains increases. This leads to a reduction in the solubility of the alginate chains thereby enhancing the viscosity of an alginate solution.

By exploiting the partial precipitation of alginate at different pH levels, the challenges typically associated with using alginate in coating materials for a food product can be reduced. It can enable the particular casing properties that are required by different sausage types to be achieved through control of pH alone, i.e. without the need to include additives found in hitherto known products.

The present disclosure is based on the discovery that carefully selected pH levels may be used to control the viscosity of a composition which comprises an anionic polysaccharide. pH levels which are too low will lead to the formation of insoluble crystalline regions, whilst pH levels which are too high will cause complete dissolution of the anionic polysaccharide in water.

More specifically, at a pH of less than 3, the alginate precipitates out of solution thus leading to a complete loss of functionality.

Even at a pH of 3.2 there are apparent issues as the pH is below the pKa of the mannuronic acid which means that negative charges will not form on the molecular surface. As a result, the G-block junction zones do not react with the Ca²⁺ ions so as to form a film/matrix structure, essentially due to a lack of electrostatic charge, and the M-block zones associate by hydrogen bonding. This results in a very weak hydrogel and therefore a very poor (essentially non-existant) casing material.

Partial precipitation of the anionic polysaccharide is observed between the pH levels used in the present invention of from 3.3 to 3.9, leading to the formation of a suitable gel. The composition is preferably maintained at a pH of from 3.4 to 3.8, and more preferably from 3.5 to 3.7. These pH levels have been found to provide a coating material having excellent viscosity for use with a food product.

The pH level may be measured using standard methods, for instance by introducing a pH probe which is attached to a pH meter into the composition.

Gel preparation may be carried out for a period of greater than 10 minutes, preferably greater than 30 minutes, and more preferably greater than 1 hour. Whilst an increase in viscosity may be observed in these periods, it is generally preferable for the viscosity of the composition to reach a steady state. Thus, in preferred embodiments, the gel preparation may be carried out for a period of greater than 3 hours, and preferably greater than 6 hours, such as 8 or 10 hours, and such as for a period of greater than 12 hours. Such a period of greater than 12 hours allows time for complete gel preparation to occur.

Gel preparation will generally be carried out at a temperature of from 10 to 40° C., preferably from 15 to 30° C., and more preferably from 20 to 25° C.

Anionic polysaccharides are understood to contain functional groups which exist in an anionic form at a pH of 7. In preferred embodiments, the anionic polysaccharide comprises uronic acid monomers. Preferably, the anionic polysaccharide comprises uronic acid monomers selected from guluronic acid and mannuronic acid. More preferably, the anionic polysaccharide is alginate, i.e. a polymer comprising guluronic acid and mannuronic acid monomers.

The alginate is can be a high-guluronic acid alginate. For instance, the ratio of guluronic acid monomers to mannuronic acid monomers in the alginate may be greater than 1:1, preferably greater than 1.5:1, and more preferably greater than 2:1. The alginate preferably comprises homopolymeric blocks of guluronic acid monomers.

The anionic polysaccharide may also be a pectin (e.g. a low methoxyl pectin) or, more preferably, a combination of an alginate and a pectin.

The composition can include the anionic polysaccharide in an amount of at least 1%, preferably at least 2%, and more preferably at least 3% by weight of the composition. The composition may comprise the anionic polysaccharide in an amount of up to 10%, preferably up to 8%, and more preferably up to 6% by weight of the composition. Thus, the composition may comprise the anionic polysaccharide in an amount of from 1 to 10%, preferably from 2 to 8%, and more preferably from 3 to 6% by weight of the composition. These levels of anionic polysaccharide are believed to provide a food product coating with an appealing texture on consumption.

However, it will be appreciated that within the range of 3 to 6% by weight of anionic polysaccharide, a significant difference in texture is discernible to the consumer. Accordingly, the amount of anionic polysaccharide that is used in the composition should be selected taking into account the desired characteristics of the final product. For instance, where the coated food product is a skinless sausage, a lower proportion of anionic polysaccharide is desirable. In these embodiments, the composition preferably comprises the anionic polysaccharide in an amount of from 3 to 4%, and preferably from 3 to 3.5% by weight of the composition. In other embodiments, a more pronounced coating texture around the food product may be desirable and so the composition may comprise the anionic polysaccharide in an amount of from 4.5 to 6%, and preferably from 5 to 6% by weight.

The target pH level may be achieved by using an acid to lower the pH. Suitable acids include food grade acids such as citric acid, lactic acid, acetic acid, ascorbic acid and glucono-δ-lactone.

However, in order to assist with maintenance of the desired pH level during gel preparation, the composition preferably comprises an acidic buffer. The acidic buffer will generally consist of an acid and a metal salt of the same acid, such as a group 1 or group 2 metal salt. Preferably, the buffer is selected from citric acid and sodium citrate; lactic acid and sodium lactate; acetic acid and sodium acetate; and ascorbic acid and sodium ascorbate.

The composition may comprise the acidic buffer in an amount of at least 0.1%, preferably at least 0.5%, and more preferably at least 1% by weight of the composition. The composition may comprise the acidic buffer in an amount of up to 10%, preferably up to 5%, and more preferably up to 3% by weight of the composition. Thus, the composition may comprise from 0.1 to 10%, preferably from 0.5 to 5%, and more preferably from 1 to 3% by weight of the composition.

Since a range of different properties are desirable in a coated food product, then one or more further ingredients may be included in the coating material to help achieve these properties. Preferably, the one or more further ingredients are selected from starches, plasticisers, smoke derivatives, hydrocolloids and insoluble fibres.

Suitable starches include tapioca starch, potato-derived starches and corn starch. Tapioca starch is preferably used. It may be desirable to use starch in the coating material as it acts as an interrupting agent, i.e. it interrupts the spatial orientation of the alginate chains producing a weaker, less perceptible casing. Starch may also be used to provide a matt appearance to a casing, as may be desired for e.g. dry fermented sausages.

Starch may be included in the coating material in an amount of at least 1%, preferably at least 2%, and more preferably at least 3% by weight of the coating material. Starch may be included in an amount of up to 10%, preferably up to 8%, and more preferably up to 6% by weight of the coating material. Thus, the coating material may comprise starch in an amount of from 1 to 10%, preferably from 2 to 8%, and more preferably from 3 to 6% by weight of the coating material.

Suitable smoke derivatives include liquid smoke. The use of smoke derivatives in the coating material is desirable because of the flavour that they impart on to the coating. Smoke derivatives may also catalyse hydrolysis of the alginate chains so that texture of the casing is shortened. Smoke derivatives may also be used to increase the viscosity of the coating material.

Smoke derivatives may be included in the coating material in an amount of at least 1%, preferably at least 2%, and more preferably at least 3% by weight of the coating material. Smoke derivatives may be included in an amount of up to 10%, preferably up to 8%, and more preferably up to 5% by weight of the coating material. Thus, the coating material may comprise smoke derivatives in an amount of from 1 to 10%, preferably from 2 to 8%, and more preferably from 3 to 5% by weight of the coating material.

In some embodiments, the level of smoke derivatives will be limited since they may lead, in combination with pH control during preparation of the coating material, to an undesirable increase in viscosity in the coating material. In these embodiments, smoke derivatives may be included in the coating material in an amount of less than 3.5%, preferably less than 1%, and more preferably less than 0.5% by weight. In some embodiments, smoke derivatives may even be absent from the coating material.

Suitable plasticisers include polyols. Glycerol is a preferred polyol, though other polyols such as monopropylene glycol or sorbitol may also be used. The use of plasticisers in the coating material is desirable because they soften the coating and provide stability during freezing. Plasticisers also lead to an increase in the viscosity of the coating material.

Plasticisers may be included in the coating material in an amount of at least 1% by weight, preferably at least 5% by weight, and more preferably at least 10% by weight of the coating material. Plasticisers may be included in an amount of up to 50%, preferably up to 40%, and more preferably up to 30% by weight of the coating material. Thus, the coating material may comprise plasticisers in an amount of from 1 to 50%, preferably from 5 to 30%, and more preferably from 10 to 20% by weight of the coating material. In some embodiments, the use of glycerol may even be avoided entirely, since desired viscosity levels may be achieved by controlling the pH during preparation of the coating material.

Suitable hydrocolloids include hydrocolloidal vegetable gums, and preferably guar gum. Other suitable hydrocolloidal vegetable gums include tara gum and locust bean gum. As with plasticisers, hydrocolloids may be useful for increasing the viscosity of the coating material.

Hydrocolloids may be included in the coating material in an amount of at least 0.1%, and preferably at least 0.25% by weight of the coating material though, in some embodiments, hydrocolloids will not be used as preferred viscosity levels may be achieved with pH control during preparation of the coating material. Hydrocolloids may be included in an amount of up to 5%, preferably up to 2.5%, and more preferably up to 1% by weight of the coating material. Thus, the coating material may comprise hydrocolloids in an amount of from 0 to 5%, preferably from 0.1 to 2.5%, and more preferably from 0.25 to 1% by weight of the coating material. The use of higher levels of hydrocolloids may lead to an undesirable oily layer on the surface of the product.

Suitable insoluble fibres include cellulose fibres, such as microcrystalline cellulose, citrus fibres and collagen. Insoluble fibres in the coating material may be useful for increasing the viscosity of the coating material.

Insoluble fibres may be included in the coating material in an amount of at least 0.5%, and preferably at least 1% by weight of the coating material though, in some embodiments, insoluble fibres will not be used as preferred viscosity levels may be achieved with pH control during preparation of the coating material. Insoluble fibres may be included in an amount of up to 10%, preferably up to 5%, and more preferably up to 3% by weight of the coating material. Thus, the coating material may comprise insoluble fibres in an amount of from 0 to 10%, preferably from 0.5 to 5%, and more preferably from 1 to 3% by weight of the coating material.

Other ingredients that may be present in the coating material include chelating agents. Suitable chelating agents include phosphates such as sodium hexametaphosphate. Colourings and flavourings, e.g. spices, may also be included in the coating material.

The one or more further ingredients are preferably present in the composition during the gel preparation. Thus, it will be appreciated that the amount by weight of the different components in the composition is the same as the amount by weight of the components in the coating material.

The composition will typically be in the form of an aqueous composition. Water may be used in the composition in an amount of at least 50%, preferably at least 60%, and more preferably at least 70% by weight of the composition.

Thus, in some embodiments, the method for preparing the coating material comprises the step of forming the composition by adding an anhydrous form of the anionic polysaccharide (e.g. a powdered form) to water. The step of forming the composition preferably further comprises adding the one or more further ingredients to the water. Preferably, the water is combined with components of the composition, if any, that are in liquid form (e.g. liquid smoke and glycerol) and subsequently combined with the dry components of the composition (e.g. powdered anionic polysaccharide). The dry components of the composition may be premixed before they are combined with the liquid.

The step of forming the composition may further comprise mixing the water, anionic polysaccharide and any additional ingredients. Methods of mixing are known in the art. High shear mixing is preferably used. Suitable devices for carrying out high shear mixing are readily available.

The gel is preferably prepared in batches. Once the gel has been prepared, it is homogenised. During the gel preparation stage, pockets of insoluble anionic polysaccharide (in which many of the anionic moieties on the polysaccharide chain have been protonated) and soluble anionic polysaccharide (in which few of the anionic moieties on the polysaccharide chains have been protonated) may form. Homogenisation distributes protonated anionic polysaccharide in the form of insoluble particles throughout the gel.

Homogenisation may be carried out by mixing the gel, e.g. using a mechanical mixer, a bowl cutter, vacuum blending, or ultrasonification. Slow blending, e.g. for a period of at least 8 hours, may also be used. Other mixing methods will be known to the person of skill in the art and may also be used. Where vacuum blending it used, the homogenisation process may be carried out for a period of at least 10 minutes, preferably at least 20 minutes, and more preferably at least 30 minutes. Vacuum blending may be carried out at a temperature of from 1 to 8° C., preferably from 2 to 6° C., for instance at about 4° C. In order to remove air, the vacuum setting is preferably set high, e.g. at its maximum.

The viscosity of the composition increases during gel preparation as electrostatic interactions develop in the composition over time. Though the viscosity is subsequently reduced during the homogenisation stage, then an overall increase in viscosity is still observed.

The viscosity of the coating material may be at least 20%, preferably at least 50%, and more preferably by at least 100% (i.e. the viscosity preferably doubles) greater than the viscosity of the composition. It will be appreciated that the viscosity of the composition is measured at the beginning of the gel preparation stage.

The coating material may have a viscosity of at least 25 Pa·s, preferably at least 28 Pa·s, and more preferably at least 30 Pa·s at 5° C. The coating material may have a viscosity of up to 80 Pa·s, such as 60 Pa·s and 40 Pa·s. Preferably the viscosity may be up to 37 Pa·s, and more preferably up to 35 Pa·s at 5° C. Thus, the coating material may have a viscosity of from 25 to 80 Pa·s, such as 25 to 40 Pa·s, preferably from 28 to 37 Pa·s, and more preferably from 30 to 35 Pa·s at 5° C.

Viscosity is measured in Pa·s using a Brookfield R/S-CPS+ Rheometer (cone and plate) which is operated with an external temperature control system at 5° C., with a C25-1 spindle utilizing a sample volume of 0.08 ml. The system settings are: CSR setting, with a shear time of 120 s but a measuring point at 60 s under linear point distribution with the shear rate parameter selected, with a start and end value set at 20 s⁻¹, and a distribution measuring points number of 60. The measuring temperature is set to 4° C.

Once the coating material has been prepared, it may be used in a method for preparing a coated food product in which the coating material is applied to a food product.

The coating material may be applied to the food product using methods that are known to the skilled person. In preferred embodiments, the coating material is extruded and applied to the food product.

The food product is preferably co-extruded with the coating material, though it will be appreciated that the coating material may be first extruded and subsequently applied to a food product. In some embodiments, the coating material may be extruded through a circular die which encircles the co-extruded food product. This is particularly preferred when the food product is a sausage, since the coating material may be extruded on to the outside surface of the sausage.

The coating material may be extruded (e.g. through a die) at a thickness of at least 50 μm, preferably at least 100 μm, and more preferably at least 150 μm. The coating material may be extruded at a thickness of up to 300 μm, preferably up to 250 μm, and more preferably up to 200 μm. Thus, the coating material may be extruded at a thickness of from 50 to 300 μm, preferably from 100 to 250 μm, and more preferably from 150 to 200 μm.

Extrusion may take place at a linear speed of at least 0.05 m/s, preferably at least 0.1 m/s, and more preferably at least 0.5 m/s. Extrusion may take place at a linear speed of up to 5 m/s, preferably up to 4.5 m/s, and more preferably up to 3.8 m/s. This, extrusion may take place at a linear speed of from 0.05 to 5 m/s, preferably from 0.1 to 4.5 m/s, and more preferably from 0.5 to 3.6 m/s. An advantage of the present invention is that the coating material may be extruded at relatively high speeds without compromising the integrity of the coating. Thus, in some embodiments, the coating material is extruded at a linear speed of greater than 1 m/s.

The extruded coating may have a tensile strength such that the load required to rupture a coating of 100 μm thickness is at least 100 g, preferably at least 150 g, and more preferably at least 200 g. The extruded coating may have a tensile strength such that the load required to rupture a coating of 100 μm thickness is up to 400 g, preferably up to 350 g, and more preferably up to 300 g. Thus, the extruded coating may have a tensile strength such that the load required to rupture a coating of 100 μm thickness is from 100 to 400 g, preferably from 150 to 350 g, and more preferably from 200 to 300 g.

Tensile strength is measured using a Brookfield CT3 texture analyser which is operated with a TA18 sphere (12.7 mm in diameter) and a fixture TA-RT-KIT. The system settings are: test type set as rupture, a test target correction of 50 g, a trigger load of 5 g and a test speed of 1 mm/s.

The coating material may be applied to the food product in an amount of at least 0.5%, preferably at least 1%, and more preferably at least 2.5% by weight of the food product. The coating material may be applied to the food product in an amount of up to 20%, preferably up to 10%, and more preferably up to 5% by weight of the food product. Thus, the coating material may be applied to the food product in an amount of from 0.5 to 20%, preferably from 1 to 10%, and more preferably from 2.5 to 5% by weight of the food product.

The coating material may be applied such that at least 50%, preferably at least 70%, and more preferably at least 90% of the surface area of the food product is coated with the coating material. Most preferably, all of the surface area of the food product is coated with the coating material.

The food product may comprise meat, fish, vegetable, or combinations thereof. The food product preferably comprises meat, such as red meat (e.g. beef, lamb, goat or bison), pork, or poultry (e.g. chicken or turkey). It will be appreciated that the food product will generally comprise further ingredients, such as flavourings (synthetic or natural, e.g. herbs), seasonings, breadcrumbs, oats, etc

The food product is preferably a moulded food product, in which the ingredients have been processed (e.g. by chopping, shredding or grinding the ingredients). Moulded food products include burgers, kebabs and sausages.

In preferred embodiments, the food product is a sausage, such as a meat sausage. Skinless meat sausages are particularly preferred. Skinless meat sausages are intended to mimic the sensory attributes of traditionally prepared hotdog sausages.

The food product may be a raw, partially cooked or cooked food product. Preferably, the food product is a raw food product.

Once the food product has been coated, the coating may be strengthened by contacting the coated food product with group 2 metal ions. Without wishing to be bound by theory, it is believed that group 2 metal ions may act as ionic cross-linkers between the chains of the anionic polymer. The group 2 metal ions are believed to interact with negatively charged groups that are present in the anionic polymer. Group 2 metal ions are particularly effective at strengthening forms of alginate which comprises homopolymeric blocks of guluronic acid monomers.

The coating may be strengthened by contacting the food product with a solution containing group 2 metal ions, for instance by immersing the food product in the solution or by spraying the solution onto the food product.

The group 2 metal ions are preferably selected from calcium ions, barium ions and magnesium ions. Calcium ions are generally preferred due their common use in food products. Suitable solutions for strengthening the casing include calcium chloride solutions. Suitable solutions may comprise group 2 metal salts in an amount of at least 5% by weight, and preferably at least 10% by weight of the solution.

Alternatively, or in addition, the food product itself may be prepared so as to comprise group 2 metal ions such as described above.

It has also surprisingly been found that carefully controlling calcium and/or phosphate levels within the food product being extruded allows for improvement of the cross-linking and binding of the coating material. More specifically, it has been found that adding calcium compound(s) in an amount of 0.1 to 0.6 grams of calcium compound(s) per kilogram of food product allows such benefits to be obtained. Preferably the amount of calcium compound(s) is 0.2 to 0.4 grams (such as 0.3 grams) of calcium compound(s) per kilogram of food product.

The calcium compound(s) may be selected from one or more of CaCl₂ (anhydrous); CaCl₂.2H₂O; calcium-lactate or calcium-acetate (and such compounds are also suitable for providing the group 2 metal ion content described above which may be applied after coating of the food product).

Where present, the phosphate compound(s) may be added in a ratio of 1:1 to 3:1 (calcium compound(s):phosphate compound(s) by mass) in the food product. Preferably the amount of phosphate compound(s) is in a ratio of 1.5:1 to 2.5:1 (such as) 2:1 (calcium compound(s):phosphate compound(s) by mass) in the food product. However, it will be appreciated that the food product may have no phosphate compound added.

The phosphate compound may be selected from sodium tripolyphosphate.

It will be appreciated that the food product itself may be a blend of food ingredients. By way of example, the food product may comprise a blend of food additives and ingredients known to those of skill in the art, including, but not limited to, flavourings, colourants, preservatives, fillers and spices. Such additives and ingredients may be added to the food product in the form of a pre-mixed blend rather than individually.

In some instances, the addition of such ingredients to the food product may result in an amount of calcium compound(s) greater than defined above. It has been found by the present inventors that when the amount if calcium compound(s) in the food product is greater than defined above, it can lead to the formation of unwanted lumps in the food product. The formation of these lumps can be avoided by addition of starch such as described below.

In such an instance, a starch constituent selected from one or more of tapioca starch, pollard, maize meal and maize starch may be added to the food product. Typically, the starch constituent is added in an amount of at least 6% by weight of the food product, such as at least 10% by weight of the food product.

Accordingly an aspect of the present invention is directed to a method for preparing a coated food product, said method comprising: preparing a food product by addition of 0.1 to 0.6 grams of a calcium compound(s) per kilogram of food product; and applying a coating material obtainable by a method as described herein the food product.

In addition, a further aspect is directed to a kit comprising: an anhydrous anionic polysaccharide, for use in the formation of a coating as described above; optionally an acid or an acidic buffer; and a calcium compound(s).

By way of example, such a kit may comprise: a dry mix alginate coating composition comprising: about 2.00% (w/w) of the coating composition of sodium alginate; about 0.50% (w/w) of the coating composition of guar gum; and about 6.00% (w/w) of the coating composition of tapioca starch; and a calcium compound(s).

It will be understood that it is envisaged that the calcium compound(s), in use, will likely be blended into a pre-mix with one or more additives and /or spices such as described herein. For the sake of ease of reference, these may be referred to as “Spice Packs”. Accordingly, the kits referred to above may comprise Spice Packs rather than solely the calcium compound(s).

Yet a further aspect of the present invention is directed to use of calcium and/or phosphate compounds in a food product for improving cross-linking and binding of alginate coating materials such as described herein.

In some embodiments, the method for preparing a coated food product comprises cooking the coated food product. For instance, the coated food product may be steamed, boiled, fried, or smoked. Preferably, the food product is cooked at a temperature of greater than 50° C., and more preferably greater than 60° C. The food product may be partially cooked, or fully cooked.

The coated food product, optionally once cooked, may be further processed by at least one of drying, chilling (e.g. at a temperature of between 1 and 10° C.), and freezing (e.g. at a temperature of less than −5° C.).

Once the coated food product has been prepared, it may be packaged. In some embodiments, the coated food product will be packaged as a single article. Generally, however, at least two, preferably at least four, and more preferably at least six coated food products will be included in a package.

The present invention provides kits which may conveniently be used for carrying out the methods disclosed herein.

In embodiments, the kit may comprise: an anionic polysaccharide (e.g. as described herein); and instructions for preparing a gel, a coating material or a coated food product using the methods disclosed herein. In some embodiments, the kit may further comprise an acid or an acidic buffer as described herein. Alternatively or additionally, the kit may comprise one or more further ingredients as described herein.

Another kit comprises: an anhydrous anionic polysaccharide (e.g. as described herein); and an acid or an acidic buffer (e.g. as described herein). In some embodiments, the kit may further comprise one or more further ingredients as described herein.

As mentioned above, by controlling the pH during preparation of the gel, advantageous properties may be imparted onto the coating of a coated food product. Thus, in some instances, a pH of from 3.3 to 3.9 may be used in a method for preparing a coated food product as described herein for enhancing the porosity of the coating. Without wishing to be bound by theory, it is believed that the enhanced porosity arises as a result of the three-dimensional structure of the anionic polysaccharide coating through which insoluble anionic polysaccharide particles are evenly distributed. In other words, the anionic polysaccharide coating can be seen to have an open, and therefore porous, structure. Generally, the porosity of the coating increases with a decrease in pH.

Enhanced porosity advantageously enables flavourings to be imparted to the food material through its coating, e.g. smoked flavours. Porosity also enables vapour to escape from the food product during cooking. Porosity may be measured by extruding the coating material onto a food product, e.g. an industry standard Russian sausage, and visually inspecting the coating of the food product during deep frying at 175° C. If the coating material has low porosity, the formation of bubbles under the skin will be observed during frying.

A pH of from 3.3 to 3.9 may also be used for improving adhesion of the coating to the food product. Adhesion of the coating to the food product may be improved before the coated food product is cooked, or during cooking of the coated food product. It is believed that the improved adhesion, particularly during cooking, arises as a result of the open structure of the anionic polysaccharide coating. The open structure is believed to cause the inner-surface of the casing which is in contact with the food product to remain tacky or sticky. Visual inspection of the food product can be used to determine whether improved adhesion is observed. For instance, visual inspection may be used to determine the % surface area in which the coating is adhered to the surface of the food product.

A pH of from 3.3 to 3.9 may also be used for reducing the tensile strength of the coating. As with increases in porosity and adhesion of the coating, the decrease in tensile strength is believed to be caused by the open structure of the anionic polysaccharide coating. Specifically, interruptions in the coating due to insoluble anionic polysaccharide particles are believed to weaken interactions between anionic polysaccharide chains, e.g. when cross-linked using a group 2 metal ion.

The advantageous properties of the coating material enable it to be used for preparing a coated food article in which the coating has a skinless feel. The coating material may also be used for improving browning of a food product coated with the material during cooking.

The methods of the present invention may be carried out using an apparatus for preparing a coated food product.

The apparatus may comprise a tank. A gel may be prepared in the tank according to a method disclosed herein. The tank may have a volume of greater than 1 L, preferably greater than 5 L, and more preferably greater than 10 L. A tank of this size enables batch-wise production of the gel.

The apparatus may further comprise a storage area containing an anhydrous anionic polysaccharide. This storage area is adapted to provide the tank with said anhydrous anionic polysaccharide.

A water inlet may be present on the tank. Water may be provided through the water inlet to the tank in order to hydrate the anhydrous anionic polysaccharide.

The apparatus may further comprise a homogeniser. The homogeniser may be used to prepare a coating material from the gel using a method disclosed herein. The homogeniser may be introduced into the tank to homogenise the gel. Alternatively, the tank may be coupled to a homogeniser and the gel passed from the tank to the homogeniser.

The apparatus may further comprise a coating device, such as an extruder. The coating device may be used to prepare a coated food product using a method disclosed herein.

The apparatus may further comprise a strengthening station, in which the coating of the coated food product is strengthened by contacting the coated food product with group 2 metal ions as described herein.

The present invention will now be illustrated by way of the following examples and with reference to the following figures in which:

### EXAMPLES

### Example 1

### Effect of pH on Viscosity

An aqueous composition containing alginate in an amount of 5% by weight of the composition was acidified to a range of pH levels using glucono-δ-lactone (GDL). The composition was left to increase in viscosity for at least 12 hours, thereby forming a gel. The viscosity of the gel was measured using a Brookfield R/S-CPS+ Rheometer (cone and plate) in the manner described above.

Results from the experiments are shown in the following table:

| pH | Viscosity (Pa · s) |
|---|---|
| 3.35 | 38.7 |
| 3.60 | 35.2 |
| 3.75 | 32.2 |
| 4.00 | 24.3 |
| 6.50 | 21.8 |
| 7.30 | 20.4 |

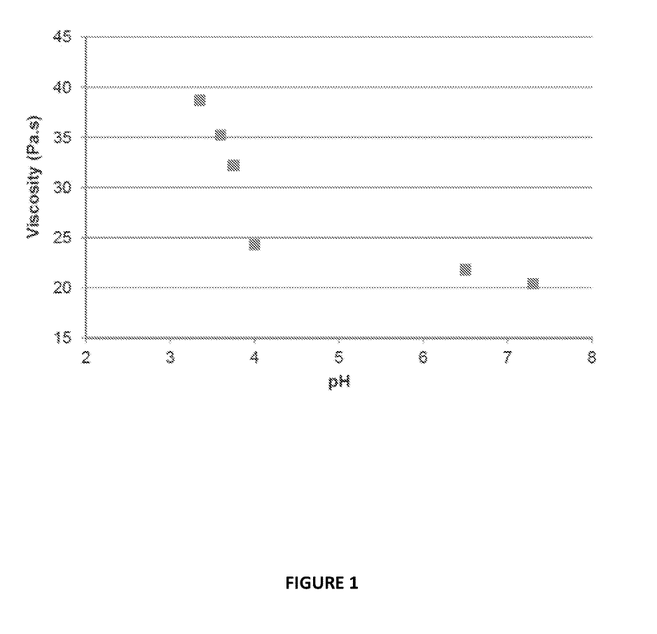

A graph of the results is shown in FIG. 1. It can be seen that large changes in viscosity are observed between the pH levels of 3.35 and 4.0, when partial precipitation of alginate is observed, whereas minimal changes are observed at pH levels of above 4.0.

In standard alginate coating compositions, pH is typically maintained at a level of greater than 4. This means that viscosity is largely independent of the level of alginate that is present in the composition, since the alginate is mostly in solution. By controlling the pH level in the methods of the present invention, viscosity and alginate levels become interdependent. This means that alginate may be used to direct final casing properties (e.g. degree of skinless feel in the coating) whilst acting as the primary or sole viscosifying agent.

### Example 2

### Effect of pH on Tensile Strength

A coating material was produced according to a method of the present invention from a composition comprising alginate in an amount of 5% by weight of the composition. The coating materials were prepared using a range of pH levels. The coating material was extruded as a film having a thickness of 100 μm. The tensile strength of the film, expressed in terms of the load required to rupture the film, was measured using a Brookfield CT3 texture analyser in the manner described above.

Results from the experiments are shown in the following table:

| pH | Tensile strength (g) |
|---|---|
| 3.35 | 97.87 |
| 3.55 | 264.03 |
| 3.75 | 346.56 |
| 4.03 | 414.09 |
| 7.5 | 738.82 |

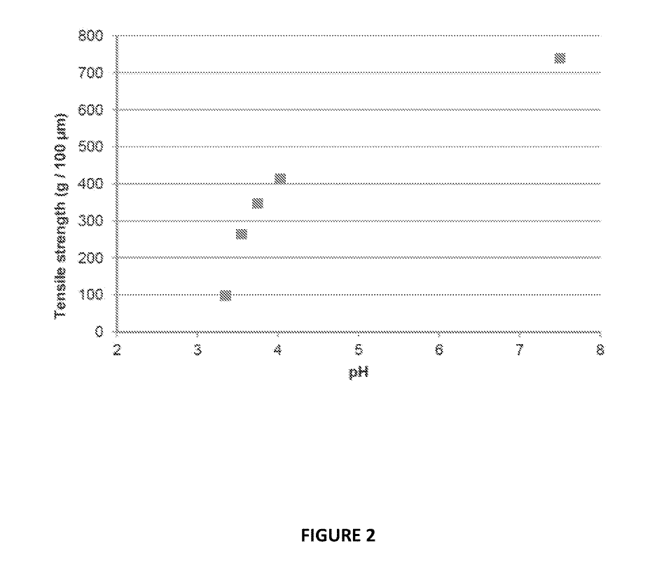

A graph of the results is shown in FIG. 2.

In standard co-ex casings the tensile strength is affected by the level of alginate, the degree of interruption and hydrolysis of the alginate network, as well as thickness of the casing. By controlling the pH level in the methods of the present invention, alginate may be used as the sole or primary regulator of the tensile strength of a casing material.

### Example 3

### Processing Conditions

Four different alginate compositions were prepared and used in a method of the present invention to prepare coating materials. The alginate used was sold under the product name ALGINEX. The level of alginate in each composition was 5% by weight of the composition, but the nature and level of acidifying agent varied. Viscosity and tensile strength were measured as in Examples 1 and 2.

Results from the experiments are shown in the following table:

| | | Sample | | | |
|---|---|---|---|---|---|
| | | 1 | 2 | 3 | 4 |
| Ingredient | Water | 89 | 92.8 | 90 | 92.5 |
| (% by weight) | Alginate | 5 | 5 | 5 | 5 |
| | Citric acid | 0 | 0 | 3 | 1.5 |
| | Sodium citrate | 0 | 0 | 2 | 1 |
| | GDL | 6 | 2.2 | 0 | 0 |

| | | | | |
|---|---|---|---|---|
| pH | 3.35 | 3.6 | 3.8 | 4 |
| Viscosity (Pa · s) | 38.7 | 35.2 | 30.5 | 24.3 |
| Tensile strength (g/100 μm) | 97.87 | 285 | 355.6 | 414.09 |

By demonstrating the effect on viscosity and tensile strength, these results indicate how partial precipitation of an alginate system may be achieved to different degrees through the use of different levels of an acid or acid buffering system.

### Example 4

### Food Product Preparation

In accordance with an aspect of the present invention, the food product itself may be prepared prior to coating by application of a pre-blended mix (referred to below as a “Spice Pack”. Examples of such Spice Pack's are as follows:

TABLE 1
Spice Pack 1

| Description | % (w/w) |
|---|---|
| SALT | 17.83 |
| CALCIUM-CHLORIDE DIHYDRATE | 3.30 |
| PEPPER WHITE | 0.69 |
| CELERY SEED | 0.53 |
| ONION DURAROME | 0.08 |
| GARLIC LIQUID | 0.03 |
| CHICKEN FLAVOUR | 17.84 |
| NUTMEG OLEORESIL | 0.07 |
| MONOSODIUM GLUTAMATE | 4.30 |
| SODIUM SULPHITE | 1.05 |
| DEXTROSE MONOHYDRATE | 7.82 |
| SODIUM TRIPOLY PHOSPHATE | 1.66 |
| PROPYLENE GLYCOL | 0.19 |
| TAPIOCA STARCH | 44.62 |
| TOTAL | 100.00 |

TABLE 2
Spice Pack 2

| Description | % (w/w) |
|---|---|
| SALT | 21.77 |
| TAPIOCA STARCH | 47.77 |
| ANTI-CAKING AGENT | 1.00 |
| CARAMEL COLOUR POWDER | 1.41 |
| PROPYLENE GLYCOL | 0.57 |
| CORIANDER OLEORESIN | 0.12 |
| CORIANDER | 5.63 |
| PEPPER BLACK | 1.70 |
| PEPPER BLACK OLEORESIN | 0.11 |
| NUTMEG OLEORESIN | 0.14 |
| EUGENOL EXTRA OLEORESIN | 0.12 |
| BEEF STOCK | 10.60 |
| SODIUM TRIPOLY PHOSPHATE | 2.00 |
| CALCIUM-CHLORIDE DIHYDRATE | 4.10 |
| QUICK RED CURE | 2.96 |
| TOTAL | 100.00 |

TABLE 3
Spice Pack 3

| Description | % (w/w) |
|---|---|
| SALT | 27.31 |
| BEEF STOCK | 5.00 |
| MEATY BASE BLEND | 6.60 |
| SODIUM TRIPOLY PHOSPHATE | 2.50 |
| NUTMEG OLEORESIN | 0.06 |
| ASCORBIC ACID | 0.70 |
| CORIANDER OLEORESIN | 0.10 |
| GINGER OLEORESIN | 0.08 |
| HICKORY SMOKE POWDER | 1.60 |
| TAPIOCA STARCH | 13.54 |
| SUGAR BROWN | 22.00 |
| FRIED ONION CONC POWDER | 0.01 |
| ONION POWDER | 3.50 |
| GARLIC POWDER | 2.80 |
| CALCIUM-CHLORIDE DIHYDRATE | 5.50 |
| WHEY POWDER | 2.20 |
| MONOSODIUM GLUTAMATE. | 2.50 |
| QUICK RED CURE | 4.00 |
| TOTAL | 100.00 |

1-43. (canceled)

44. A method for preparing a coating material for a food product, the method comprising:
a gel preparation stage in which a composition comprising an anionic polysaccharide is maintained at a pH of from 3.3 to 3.9 to increase its viscosity; and
a coating formation stage in which the gel is homogenized.

45. The method of claim 44, wherein the composition is maintained at a pH of from 3.4 to 3.8.

46. The method of claim 44, wherein the gel preparation stage is at least one member of a group consisting of: carried out for a period of greater than 10 minutes and carried out at a temperature of from 10 to 40° C.

47. The method of claim 44, wherein the anionic polysaccharide is an alginate, and/or wherein the composition comprises the anionic polysaccharide in an amount of from 1 to 10% by weight of the composition.

48. The method of claim 44, wherein the composition further comprises an acidic buffer.

49. The method of claim 44, wherein the method comprises one or more further ingredients in the coating material, the one or more further ingredients being selected from starches, plasticizers, smoke derivatives, hydrocolloids and insoluble fibers.

50. The method of claim 44, wherein the method comprises forming the composition by adding water to an anhydrous form of the anionic polysaccharide.

51. The method of claim 44, wherein the viscosity of the coating material is at least 20% greater than the viscosity of the composition, and/or wherein the gel has a viscosity of from 25 to 40 Pa·s at 5° C.

52. A coating material obtainable by:
a gel preparation stage in which a composition comprising an anionic polysaccharide is maintained at a pH of from 3.3 to 3.9 to increase its viscosity; and
a coating formation stage in which the gel is homogenized.

53. A method for preparing a gel for use in preparing a coating material for a food product, the method comprising maintaining a composition comprising an anionic polysaccharide at a pH of from 3.3 to 3.9 to increase its viscosity.

54. A gel obtainable by maintaining a composition comprising an anionic polysaccharide at a pH of from 3.3 to 3.9 to increase its viscosity.

55. A method for preparing a coated food product, the method comprising:
a coating step, the coating step comprising applying a coating material obtainable by a gel preparation stage in which a composition comprising an anionic polysaccharide is maintained at a pH of from 3.3 to 3.9 to increase its viscosity and a coating formation stage in which the gel is homogenized.

56. The method of claim 55, wherein the coating material is extruded on to the food product.

57. The method of claim 55, wherein at least 50% of the surface area of the food product is coated with the coating material.

58. The method of claim 55, wherein the food product comprises meat, fish, vegetable, or combinations thereof.

59. The method of claim 55, wherein the method further comprises strengthening the coating by contacting the coated food product with group 2 metal ions.

60. The method according to claim 55, wherein the food product comprises calcium compound(s) in an amount of 0.1 to 0.6 grams of calcium compound(s) per kilogram of food.

61. A coated food product obtainable by a coating step, the coating step comprising applying a coating material obtainable by a gel preparation stage in which a composition comprising an anionic polysaccharide is maintained at a pH of from 3.3 to 3.9 to increase its viscosity and a coating formation stage in which the gel is homogenized.

62. A kit comprising:
an anionic polysaccharide; and
instructions for preparing a coating material using a gel preparation stage in which a composition comprising an anionic polysaccharide is maintained at a pH of from 3.3 to 3.9 to increase its viscosity and a coating formation stage in which the gel is homogenized.

63. A kit comprising:
an anhydrous anionic polysaccharide; and
an acid or an acidic buffer.

64. An apparatus for preparing a coated food product, wherein the apparatus comprises:
a tank in which a gel is prepared using a gel preparation stage in which a composition comprising an anionic polysaccharide is maintained at a pH of from 3.3 to 3.9 to increase its viscosity;
a homogeniser in which a coating material is prepared from the gel; and
a coating device in which a coated food product is prepared by applying the coating material to a food product;
wherein the apparatus comprises a storage area containing an anhydrous anionic polysaccharide, said storage area adapted to provide the tank with said anhydrous anionic polysaccharide.
